(19) United States
(12) Patent Application Publication
(10) Pub. No.: US 2026/0064915 A1
(43) Pub. Date: Mar. 5, 2026

(54) METHOD FOR PREDICTING URBAN REGIONAL TRAFFIC FLOW CONSIDERING MULTIPLE SPATIO-TEMPORAL GRANULARITIES

(71) Applicant: Hangzhou Dianzi University, Hangzhou City (CN)

(72) Inventors: Liming Tu, Hangzhou City (CN); Xiaoying Shi, Hangzhou City (CN); Haitao Xu, Hangzhou City (CN); Geng Liu, Hangzhou City (CN); Guoyi Li, Hangzhou City (CN); Bowen He, Hangzhou City (CN)

(21) Appl. No.: 19/030,976

(22) Filed: Jan. 17, 2025

(30) Foreign Application Priority Data
Aug. 27, 2024 (CN) 202411182775.5

(51) Int. Cl. G06F 30/27; G06F 17/11; G06F 111/10

(52) U.S. Cl. CPC G06F 30/27; G06F 17/11; G06F 2111/10

(57) ABSTRACT

A method for predicting urban regional traffic flow considering multiple spatio-temporal granularities is provided. In this method, a traffic flow dataset, a regional dataset, a weather dataset, and a Points of Interest (POI) dataset are acquired first. Then, data in the traffic flow dataset is preprocessed, and attribute features as well as flow sub-tensors at three temporal granularities are constructed. Next, two regional association graphs are constructed for each area, including a distance graph and a semantic graph. Finally, spatio-temporal network (STN) blocks are constructed, and based on the distance graph and the semantic graph, spatio-temporal representations at each temporal granularity are obtained through the STN blocks combined with the attribute features and the flow sub-tensors at the three temporal granularities. The spatio-temporal representations of the data at each temporal granularity are fused for flow predictions and back-propagation is performed to obtain the final model.

### CROSS REFERENCE TO RELATED APPLICATION

This patent application claims the benefit and priority of Chinese Patent Application No. 2024111827755, filed with the China National Intellectual Property Administration on Aug. 27, 2024, the disclosure of which is incorporated by reference herein in its entirety as part of the present application.

### TECHNICAL FIELD

The present disclosure relates to the field of information technology, and in particular, to a method for predicting urban regional traffic flow considering multiple spatio-temporal granularities.

### BACKGROUND

Accurate prediction of urban regional traffic flow can not only improve the operational efficiency of urban traffic but also promote sustainable urban development and enhance the quality of life for residents. Early traffic flow prediction models used statistical methods or traditional machine learning methods to predict the inflow and outflow of regions, requiring manual feature extraction and failing to fully utilize the potential features contained in traffic data. With the development of deep learning, researchers have begun to construct end-to-end neural network models to predict traffic flow. Convolutional neural networks are used to capture spatial dependencies, while recurrent neural networks are used to capture temporal dependencies. However, the convolutional neural networks can only be applied to regular grids and Euclidean spaces, making it difficult to effectively model traffic networks with complex topological structures.

In recent years, researchers have modeled the spatial dependencies of regional traffic flow data by constructing predefined graph structures and using graph convolutional networks. These graph structures typically only consider distance relationships between regions, neglecting user travel patterns, and rarely consider surrounding land use characteristics that influence travel patterns, thus limiting the model by prior knowledge. In terms of capturing temporal dependencies, commonly used models include Long Short-Term Memory networks (LSTMs) or Gated Recurrent Units (GRUs), but they suffer from gradient vanishing issues and struggle to model long-term dependencies. Additionally, historical traffic flow can influence future traffic flow in different ways; for example, flow from adjacent hours and flow at a specific time point on past dates can affect flow at a future time point. Flow data also exhibits non-stationary characteristics. In other words, the statistical features and joint distributions thereof change over time. Therefore, there is a need to design a method for predicting urban regional traffic flow that constructs effective graph structures to encode features related to distance and user travel behavior while considering the temporal multi-granularity features and non-stationarity of the data, thereby improving the accuracy of regional flow predictions.

### SUMMARY

To address the above issues, the present disclosure designs a method for predicting urban regional traffic flow considering multiple spatio-temporal granularities. Spatially, it captures both the distance correlation and traffic similarity between areas while considering the impact of land use characteristics on travel patterns. Temporally, it captures time correlations at different granularities and the non-stationary characteristics of data, and incorporates weather and date attributes into a model to enhance the accuracy of regional flow predictions, thereby better alleviating traffic congestion and promoting the construction of smart cities.

A method for predicting urban regional traffic flow considering multiple spatio-temporal granularities includes the following steps:
Step 1: Acquire a traffic flow dataset, a regional dataset, a weather dataset, and a Points of Interest (POI) dataset.
Step 2: Preprocess data in the traffic flow dataset and construct attribute features.
Step 3: Construct flow sub-tensors at three temporal granularities based on the preprocessed traffic flow data.

Since traffic flow from different past periods will influence future flow in various ways, the present disclosure defines temporal patterns of regional traffic flow at three temporal granularities: a recent pattern, a daily periodic pattern, and a weekly periodic pattern. An original flow tensor X is organized into three sub-tensors, each reflecting one of the three patterns.

Step 4: Construct two regional association graphs for each area, including a distance graph and a semantic graph.

Different spatial correlations can affect traffic flow patterns of the areas. First, there may be close traffic associations between adjacent areas. Second, due to spatial differences in land use characteristics that influence travel activities, two areas that are far apart may also exhibit similar usage patterns. For example, areas where business districts are located may experience high inflow during morning rush hours. Therefore, for each area, two types of regional association graphs are constructed: a distance graph and a semantic graph, which capture spatial proximity relationships and semantic relationships with similar functional attributes, respectively.

Step 5: Construct spatio-temporal network (STN) blocks, and based on the distance graph and the semantic graph, obtain spatio-temporal representations at each temporal granularity through the STN blocks combined with the attribute features and the flow sub-tensors at the three temporal granularities.

Step 6: Fuse the spatio-temporal representations of the data at each temporal granularity for flow predictions and perform back-propagation to obtain a model.

The model calculates loss and optimizes parameters through backpropagation. After the model is constructed, predictions are made using the prediction model based on test data to obtain final regional flow prediction results.

Compared with the prior art, the present disclosure has the following advantages and effects:

The features and innovations of the method of the present disclosure are as follows: Existing methods for predicting urban regional traffic flow only capture spatio-temporal information from a single temporal or spatial granularity, which reduces prediction accuracy. The present disclosure proposes a method for predicting urban regional traffic flow considering multiple spatio-temporal granularities. Spatially, distance graphs and semantic graphs are constructed to reflect the geographical adjacency and semantic relevance between areas, thereby better capturing multimodal spatial associations. Temporally, the original traffic data is organized into recent sub-tensors, daily periodic sub-tensors, and weekly periodic sub-tensors to represent temporal characteristics of urban area flow at three granularities, and a non-stationary transformer is used to capture non-stationary features of flow data at each temporal granularity, thereby improving the accuracy of urban regional traffic flow predictions.

### BRIEF DESCRIPTION OF THE DRAWINGS

FIG. 1 is a diagram showing data processing and a model structure; and

FIG. 2 shows a structure of a spatio-temporal network (STN) block.

### DETAILED DESCRIPTION OF THE EMBODIMENTS

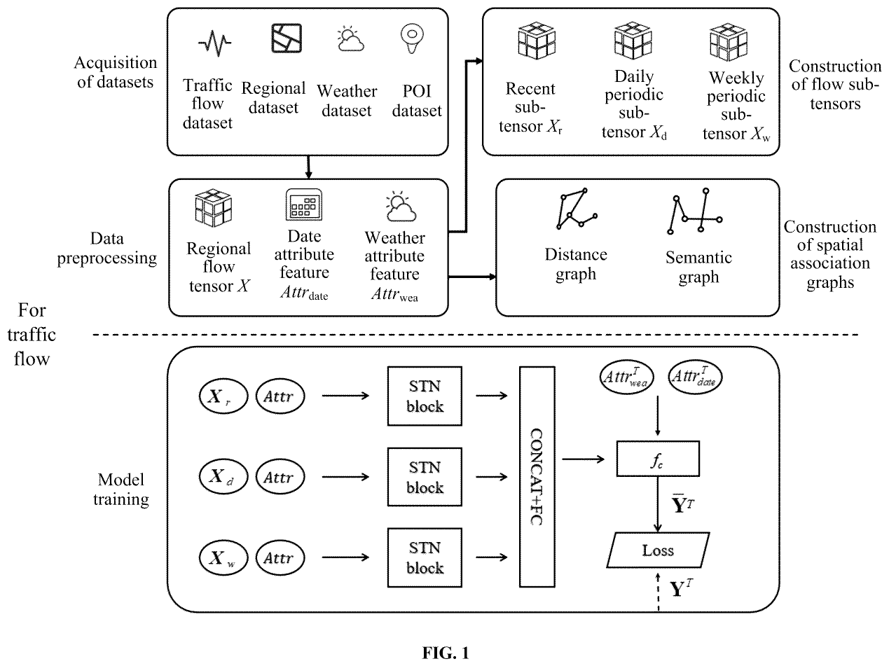

A method for predicting urban regional traffic flow considering multiple spatio-temporal granularities is provided, with the structure as shown in FIG. 1. The method includes the following steps:

Step 1: Acquire a traffic flow dataset, a regional dataset, a weather dataset, and a Points of Interest (POI) dataset.

The traffic flow dataset, such as a taxi dataset and a shared bicycle dataset, is acquired. Each record in the dataset contains an entry time, an entry area ID, an exit time, and an exit area ID.

The regional dataset is acquired, where each record in the dataset contains an area ID, latitude and longitude of an area center, and boundary information of an area.

The POI dataset is acquired, which includes POI type labels related to locations, such as schools, companies, and tourist attractions. Each record contains latitude and longitude of a location and a corresponding POI type label.

The weather dataset is acquired, which includes temperature, precipitation, and weather conditions, where weather conditions include values such as sunny, light rain, heavy rain, light snow, and heavy snow.

Step 2: Preprocess data in the traffic flow dataset and construct attribute features.

Step 2.1: Preprocess traffic flow data.

The records in the traffic flow dataset are summarized by hour based on the entry time to obtain a historical flow sequence for each area in a city. It is assumed that a city contains N areas, with X=(X⁰, . . . , X^{t}, . . . , X^{T-1})∈□^{N×F×T} representing regional flow tensors, where T represents a time step length in hours. X^{t} represents a flow matrix for all areas in the city at time t. F represents the number of flow features, including inflow and outflow.

Step 2.2: Construct the attribute features.

Attribute features Attr are constructed, including date attribute features Attr_{date} and weather attribute features Attr_{wea} For a time step, Attr_{date} includes three features: whether it is a weekday, which hour of the day it is, and which day of the week it is; Attr_{wea} includes temperature, precipitation, and weather conditions, where the weather conditions are represented in a composite one-hot encoding format, that is, corresponding bits can be 1 on multiple positions simultaneously.

Step 3: Construct flow sub-tensors at three temporal granularities based on the preprocessed traffic flow data.

Since traffic flow from different past periods will influence future flow in various ways, the present disclosure defines temporal patterns of regional traffic flow at three temporal granularities: a recent pattern, a daily periodic pattern, and a weekly periodic pattern. An original flow tensor X is organized into three sub-tensors, each reflecting one of the three patterns. It is assumed that t₀⁻¹ represents a current time, and t_{O} represents a prediction time point. A recent sub-tensor Xᵣ includes flow of an area in past few hours, defined as:

$${X}_{r} = ( {X}_{{t}_{0} - {T}_{r}} , {X}_{{t}_{0} - {T}_{r} + 1} , … , {X}_{{t}_{0} - 1} ) , {X}_{r} ∈ {⊓}^{N \times F \times {T}_{r}} \qquad ( 1 )$$

where N is the number of areas, F is the number of features, and Tᵣ is a historical window size at an adjacent temporal granularity.

A daily periodic sub-tensor X_{d} is formed by flow in the same hour as the prediction time point from past few days, defined as:

$${{X}_{d} = ( {X}_{{t}_{0} - {T}_{d} \times {P}_{d}} , {X}_{{t}_{0} - ( {T}_{d} - 1 ) \times {P}_{d}} , … , {X}_{{t}_{0} - 1 \times {P}_{d}} ) , {X}_{d} ∈ ⌉}^{N \times F \times {T}_{d}} \qquad ( 2 )$$

where T_{d} is a historical window size at a daily periodic temporal granularity, that is, the number of past days taken into consideration. P_{d}=24 represents the 24 hours in a day.

A weekly periodic sub-tensor X_{w} is formed by flow, having the same weekly attribute and at the same time point as the prediction time point, from past few weeks. For example, for data at 7 AM on Monday, flow at 7 AM on Monday in the previous few weeks is obtained. X_{w} is defined as:

$${X}_{w} = ( {X}_{{t}_{0} - {T}_{w} \times {P}_{w}} , {X}_{{t}_{0} - ( {T}_{w} - 1 ) \times {P}_{w}} , … , {X}_{{t}_{0} - 1 \times {P}_{w}} ) , {X}_{w} ∈ {⊐}^{N \times F \times {T}_{w}} \qquad ( 3 )$$

where T_{w} is a historical window size at a weekly periodic temporal granularity, that is, the number of past weeks taken into consideration. P_{w}=168 represents the number of hours in a week.

Step 4: Construct two regional association graphs for each area, including a distance graph and a semantic graph.

Different spatial correlations can affect traffic flow patterns of the areas. First, there may be close traffic associations between adjacent areas. Second, due to spatial differences in land use characteristics that influence travel activities, two areas that are far apart may also exhibit similar usage patterns. For example, areas where business districts are located may experience high inflow during morning rush hours. Therefore, for each area, two types of regional association graphs are constructed: a distance graph and a semantic graph, which capture spatial proximity relationships and semantic relationships with similar functional attributes, respectively.

Step 4.1: Construct the distance graph.

The distance graph G_{d}=(V, E_{d}, A_{d}) is used to encode geographical associations between areas, where V∈□^{N} represents a set of area center points, while an edge set (vᵢ, vⱼ)∈E_{d} represents geographical connection relationships between areas. Each element A_{d}(i, j) in an adjacency matrix A_{d} is defined as:

$${A}_{d} ( i , j ) = \{ \begin{matrix}1 , & if norm ( dis ( i , j ) ) \leq {λ}_{d} , & & i \neq j \\ 0 , & if norm ( dis ( i , j ) ) > {λ}_{d} , & or & i = j\end{matrix} \qquad ( 4 )$$

where dis(i, j) represents a distance between area i and area j, and λ_{d} is a predefined distance threshold. norm( ) denotes a normalization operation. If norm(dis(i, j)≤λ_{d}, it indicates that the distance between area i and area j is close, and the two areas are geographically adjacent, and A_{d}(i, j)=1 that is, (vᵢ, vⱼ)∈E_{d}; otherwise, A_{d}(i, j)=0, that is, (vᵢ,vⱼ)∉E_{d}.
Step 4.2: Construct the semantic graph.

The semantic graph Gₛ=(V, Eₛ, Aₛ, Rₛ) is used to encode semantic relationships between areas, where V∈␣^{N} represents a set of area center points, while edges (vᵢ, vⱼ)∈Eₛ represent semantic connection relationships between areas. Aₛ represents an adjacency matrix of the semantic graph, and Rₛ represents a node type set.

First, a Pearson Correlation Coefficient (PCC) is used to calculate similarities between nodes based on historical traffic patterns of the areas. Historical flow of area i can be represented as

$${F}_{i} = ( {I}_{i}^{0} , {O}_{i}^{0} , … , {I}_{i}^{t} , {O}_{i}^{t} , … , {I}_{i}^{T - 1} , {O}_{i}^{T - 1} ) ,$$

where T is a time step length;

$${I}_{i}^{t} and {O}_{i}^{t}$$

represent inflow and outflow of area i at time step t; a similarity PCC_{i,j} between nodes vᵢ and vⱼ is defined as:

$${PCC}_{i , j} = \frac{{\sum }_{t = 0}^{T - 1} ( {F}_{i} ( t ) - {\overline{F}}_{i} ) ( {F}_{j} ( t ) - {\overline{F}}_{j} )}{\sqrt{{\sum }_{t = 0}^{T - 1} {( {F}_{i} ( t ) - {\overline{F}}_{i} )}^{2}} \sqrt{{\sum }_{t = 0}^{T - 1} {( {F}_{j} ( t ) - {\overline{F}}_{j} )}^{2}}} \qquad ( 5 )$$

where F̅ᵢ and F̅ⱼ are average flow values for area i and area j, respectively, and t is a time step.

Then, based on the set of area center points V and PCC similarities between nodes, an edge set Eₛ of the semantic graph is constructed using a complex network construction algorithm. In the complex network construction algorithm, Aₛ is first initialized to be a zero matrix, indicating that initially, all nodes are disconnected, and each node forms a node group. Then, an iterative merging operation is performed on the node groups. When the number of node groups is greater than 1, two most similar node groups are found based on similarities between node groups. The similarity between node groups is defined as a maximum PCC similarity from all node pairs between the node groups. Most similar k pairs of nodes are selected from two node groups, and if a PCC similarity of two nodes in a pair is greater than a threshold λₛ, corresponding positions in Aₛ are set to 1, indicating that the two nodes are connected. The found two most similar node groups are merged into one, and the similarities between the node groups are updated. The iterative merging operation stops when there is only one node group left. Finally, diagonal values of Aₛ are set to 1, indicating that each node is connected to itself, resulting in final Aₛ through calculation, and edge connection relationships Eₛ are obtained, that is, the edge set.

Finally, based on distribution of POIs within each area, a semantic type is assigned to each area, resulting in the node type set Rₛ. For each area, all POIs within the area are first obtained, and then a semantic type is assigned to each area based on a POI category with highest distribution frequency in the area, defined as follows:

$${p}_{i}^{j} = \frac{{c}_{i}^{j}}{{\sum }_{k = 1}^{N} {c}_{k}^{j}} \qquad ( 6 )$$

$${R}_{i} = {arg max}_{j} {p}_{i}^{j} \qquad ( 7 )$$

where

$${c}_{i}^{j} and {p}_{i}^{j}$$

represent the number and distribution frequency of POI category j in area i, respectively. Rᵢ represents a semantic type of area i (node i). The resulting semantic graph Gₛ not only reflects the similarity of usage patterns between areas but also encodes semantic functional attributes of the areas.

Step 5: Construct spatio-temporal network (STN) block, and based on the distance graph and semantic graph, obtain spatio-temporal representations at the temporal granularities through the STN block combined with the attribute features and the flow sub-tensors at the three temporal granularities.

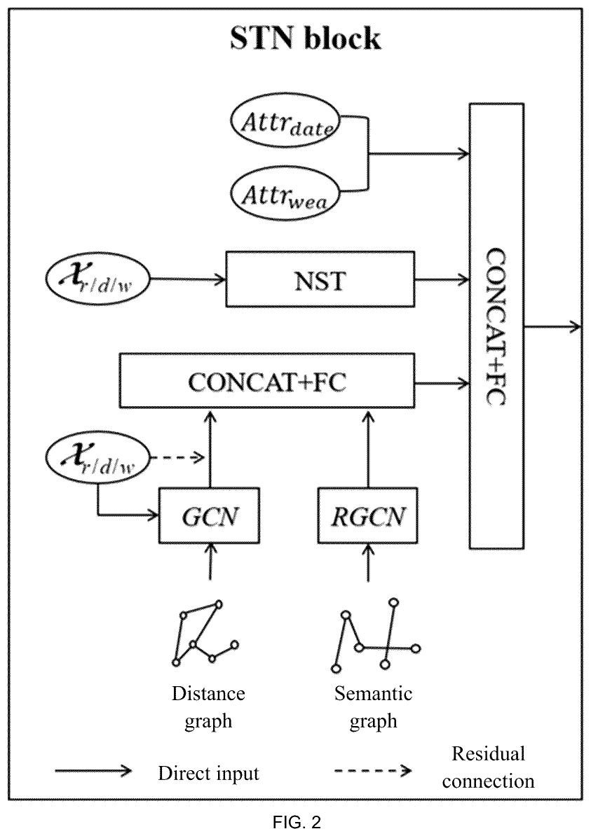

The STN block is constructed, as shown in FIG. 2. In the STN block, the distance graph and semantic graph are processed separately using a graph convolutional network and a relational graph convolutional network, respectively, and are fused through a fully connected layer to obtain a spatial representation X_{S} at a specific temporal granularity:

$${X}_{S} = {f}_{c} ( {f}_{gcn} ( {G}_{d} , {Xr}_{r / d / w} ) + {f}_{rgcn} ( {G}_{s} ) ) \qquad ( 8 )$$

where Xr_{r/d/w} represents a specific flow sub-tensor (Xᵣ or X_{d} or X_{w}), and f_{gcn} and f_{rgcn} represent the graph convolutional network and the relational graph convolutional network, respectively, while f_{c} is the fully connected layer. f_{gcn} is used to effectively aggregate information from adjacent nodes to obtain geographical connection relationships between areas in the distance graph. In f_{gcn}, residual connections are used to accelerate training convergence, while f_{rgcn} is used to capture complex semantic information contained in the semantic graph. By fusing results of processing by f_{gcn} and f_{rgcn}, a spatial representation of an urban area network is obtained.

Then, a Non-stationary Transformer (NST) algorithm is used to capture temporal dependencies, resulting in a temporal representation at a specific temporal granularity, defined as:

$${X}_{T} = {f}_{c} ( {f}_{NST} ( {Xr}_{r / d / w} ) ) \qquad ( 9 )$$

where f_{NST} and f_{c} represent a non-stationary transformer layer and a fully connected layer, respectively.

Finally, the date attribute features Attr_{date} and the weather attribute features Attr_{wea} are concatenated with the spatial representation X_{S} and the temporal representation X_{T}, and combined data is passed through the fully connected layer to obtain a spatio-temporal representation X̅:

$${X}^{-} = {f}_{c} ( {X}_{S} , {X}_{T} , {Attr}_{date} , {Attr}_{wea} ) ) \qquad ( 10 )$$

Step 6: Fuse the spatio-temporal representations of the data at each temporal granularity for flow predictions and perform back-propagation to obtain a model.

First, three STN blocks are used to process the recent sub-tensor Xᵣ, the daily periodic sub-tensor X_{d}, and the weekly periodic sub-tensor X_{w}, respectively, to obtain spatio-temporal representations at each temporal granularity: X̅ᵣ, X̅_{d}, and X̅_{w}, and then the obtained spatio-temporal representations fused:

$${X}^{∼} = {f}_{c} ( {X}_{r}^{-} , {X}_{d}^{-} , {X}_{w}^{-} ) \qquad ( 11 )$$

where f_{c} is the fully connected layer.

Then, weather forecast information and a date attribute at a corresponding time point are input into the model as external factors to predict regional flow at time step T, with a model output represented as:

$${\overline{Y}}^{T} = {f}_{c} ( {X}^{∼} , {Attr}_{wea}^{T} , {Attr}_{date}^{T} ) \qquad ( 12 )$$

where Y̅^{T} is predicted urban regional traffic flow at time step T, including inflow and outflow, and

$${Attr}_{wea}^{T} and {Attr}_{date}^{T}$$

are weather attribute features and date attribute features at time step T, respectively.

Finally, L2 loss is used as a loss function, defined as follows:

$$L ( θ ) = {‖ {\overline{Y}}^{T} - {Y}^{T} ‖}_{2}^{2} \qquad ( 13 )$$

where Y^{T} and Y̅^{T} represent a true flow matrix and a predicted flow matrix at time step T, respectively, and θ is a learnable parameter in the network. The model calculates loss and optimizes parameters through backpropagation. After the model is constructed, predictions are made using the prediction model based on test data to obtain final regional traffic flow prediction results.

### EMBODIMENT

For New York shared bicycle data, regional traffic flow predictions are made. An area center is a position of a shared bicycle station, and area boundaries are defined as a circular area with a radius of 250 meters centered around the station. To demonstrate the effectiveness of this method, comparative experiments are conducted with commonly used models in existing related technologies, including the Historical Average (HA) model, Autoregressive Integrated Moving Average (ARIMA) model, LSTM, GRU, Graph Convolutional Network (GCN), Spatio-Temporal Lightweight Graph GRU (STLGRU), Attention-based Spatio-Temporal Graph Convolutional Network (ASTGCN), Spatio-Temporal Adaptive Embedding Transformer (STAEformer), and Spatio-Temporal Graph Neural Controlled Differential Equation (STG-NCDE). The evaluation metrics used are Mean Absolute Error (MAE) and Root Mean Square Error (RMSE), where smaller values of the two metrics indicate better prediction performance. The experimental results are shown in Table 1. The method of the present disclosure shows significant performance improvements compared to other methods, indicating that by considering multiple temporal and spatial granularities, the method of the present disclosure can effectively enhance prediction accuracy.

TABLE 1
Performance Comparison of Different Models

| | |
|---|---|
| Inflow | Outflow |

| Model | MAE | RMSE | MAE | RMSE |
|---|---|---|---|---|
| HA | 1.2611 | 2.3728 | 1.2466 | 2.3083 |
| ARIMA | 1.6174 | 3.2945 | 1.6242 | 3.2945 |
| LSTM | 0.9951 | 1.8217 | 0.9702 | 1.7464 |
| GRU | 1.0001 | 1.8585 | 0.9728 | 1.7779 |
| GCN | 0.9839 | 1.6867 | 0.9893 | 1.6658 |
| ASTGCN | 0.8579 | 1.5416 | 0.8520 | 1.4986 |
| STAEFORMER | 1.7016 | 2.6415 | 1.6723 | 2.5784 |
| STG-NCDE | 1.0617 | 2.0661 | 1.2089 | 2.3277 |
| Present disclosure | 0.8064 | 1.4692 | 0.7819 | 1.4225 |

What is claimed is:

1. A method for predicting urban regional traffic flow considering multiple spatio-temporal granularities, comprising the following steps:
step 1: acquiring a traffic flow dataset, a regional dataset, a weather dataset, and a Points of Interest (POI) dataset;
step 2: preprocessing data in the traffic flow dataset and constructing attribute features;
step 3: constructing flow sub-tensors at three temporal granularities based on the preprocessed traffic flow data;
step 4: constructing two regional association graphs for each area, comprising a distance graph and a semantic graph;
step 5: constructing spatio-temporal network (STN) blocks, and based on the distance graph and the semantic graph, obtaining spatio-temporal representations at each temporal granularity through the STN blocks combined with the attribute features and the flow sub-tensors at the three temporal granularities;
step 6: fusing the spatio-temporal representations of the data at each temporal granularity for flow predictions and performing back-propagation.

2. The method for predicting urban regional traffic flow considering multiple spatio-temporal granularities according to claim 1, wherein the traffic flow dataset comprises a taxi dataset and a shared bicycle dataset, and each record in the dataset contains an entry time, an entry area ID, an exit time, and an exit area ID;
each record in the regional dataset contains an area ID, latitude and longitude of an area center, and boundary information of an area;
the weather dataset comprises temperature, precipitation, and weather conditions; and
the POI dataset comprises POI type labels related to locations, and each record in the POI dataset contains latitude and longitude of a location and a corresponding POI type label.

3. The method for predicting urban regional traffic flow considering multiple spatio-temporal granularities according to claim 1, wherein step 2 is specifically implemented as follows:
step 2.1: summarizing the records in the traffic flow dataset by hour based on the entry time to obtain a historical flow sequence for each area in a city, where it is assumed that a city contains N areas, with X=(X⁰, . . . , X^{t}, . . . , X^{T-1})∈R^{N×F×T} representing regional flow tensors, wherein T represents a time step length in hours; X^{t} represents a flow matrix for all areas in the city at time t, and F represents the number of flow features, comprising inflow and outflow; and
step 2.2: constructing attribute features, comprising date attribute features Attr_{date} and weather attribute features Attr_{wea}, wherein for a time step, Attr_{date} comprises: whether it is a weekday, which hour of the day it is, and which day of the week it is; Attr_{wea} comprises temperature, precipitation, and weather conditions, and the weather conditions are represented in a composite one-hot encoding format.

4. The method for predicting urban regional traffic flow considering multiple spatio-temporal granularities according to claim 3, wherein a specific process of constructing the flow sub-tensors at the three temporal granularities comprises:
defining temporal patterns of regional traffic flow at three temporal granularities: a recent pattern, a daily periodic pattern, and a weekly periodic pattern; and organizing an original flow tensor X into three sub-tensors, each reflecting one of the three patterns;
wherein it is assumed that t₀−1 represents a current time, and t₀ represents a prediction time point; a recent sub-tensor Xᵣ comprises flow of an area in past few hours, defined as:
$${𝒳}_{r} = ( {X}_{{t}_{0} - {T}_{r}} , {X}_{{t}_{0} - T , + 1} ) , … , {X}_{{t}_{0} - 1} ) , {𝒳}_{r} ∈ {ℝ}^{N \times F \times T ,} \qquad ( 1 )$$
wherein N is the number of areas, F is the number of features, and Tᵣ is a historical window size at an adjacent temporal granularity;
a daily periodic sub-tensor X_{d} is formed by flow in the same hour as the prediction time point from past few days, defined as:
$${𝒳}_{r} = ( {X}_{{t}_{0} - {T}_{d} \times {P}_{d}} , {X}_{{t}_{0} - ( {T}_{d} - 1 ) \times {P}_{4}} , … , {X}_{{t}_{0} - 1 \times {P}_{d}} ) , {𝒳}_{d} ∈ {ℝ}^{N \times F \times {T}_{d}} \qquad ( 2 )$$
wherein T_{d} is a historical window size at a daily periodic temporal granularity, that is, the number of past days taken into consideration, P_{d}=24, representing the 24 hours in a day; and
a weekly periodic sub-tensor X_{w} is formed by flow, having the same weekly attribute and at the same time point as the prediction time point, from past few weeks, and X_{w} is defined as:
$${𝒳}_{w} = ( {X}_{{t}_{0} - {T}_{w} \times {P}_{w} ,} {X}_{{t}_{0} - ( {T}_{w} - 1 ) \times {P}_{w}} , … , {X}_{{t}_{0} - 1 \times {P}_{w}} ) , {𝒳}_{w} ∈ {ℝ}^{N \times F \times {T}_{w}} \qquad ( 3 )$$
wherein T_{w} is a historical window size at a weekly periodic temporal granularity, that is, the number of past weeks taken into consideration, P_{w}=168, representing the number of hours in a week.

5. The method for predicting urban regional traffic flow considering multiple spatio-temporal granularities according to claim 4, wherein a specific process of constructing the two regional association graphs comprises:
step 4.1: constructing the distance graph, and encoding geographical associations between areas by using the distance graph G_{d}=(V, E_{d}, A_{d}), wherein V∈ [symbol] ^{N} represents a set of area center points, while an edge set (vᵢ, vⱼ)∈E_{d} represents geographical connection relationships between areas, and each element A_{d}(i, j) in an adjacency matrix A_{d} is defined as:
$${A}_{d} ( i , j ) = \{ \begin{matrix}1 , & if norm ( dis ( i , j ) ) \leq {λ}_{d} , & i \neq j \\ 0 , & if norm ( dis ( i , j ) ) > {λ}_{d} , or & i = j\end{matrix} \qquad ( 4 )$$
wherein dis(i, j) represents a distance between area i and area j, and λ_{d} is a predefined distance threshold; norm( ) denotes a normalization operation; if norm(dis(i, j)≤λ_{d}, it indicates that the two areas are geographically adjacent, and A_{d}(i, j)=1, that is, (vᵢ, vⱼ)∈E_{d}; otherwise, A_{d}(i, j)=0, that is, (vᵢ, vⱼ)∉E_{d};
step 4.2: constructing the semantic graph, and encoding semantic relationships between areas by using the semantic graph Gₛ=(V, Eₛ, Aₛ, Rₛ), wherein V∈ [symbol] ^{N} represents a set of area center points, while edges (vᵢ, vⱼ)∈Eₛ represent semantic connection relationships between areas; Aₛ represents an adjacency matrix of the semantic graph, and Rₛ represents a node type set;
wherein, first, a Pearson Correlation Coefficient (PCC) is used to calculate similarities between nodes based on historical traffic patterns of the areas; historical flow of area i is represented as
$${F}_{i} = ( {I}_{i}^{0} , {O}_{i}^{0} , … , {I}_{i}^{t} , {O}_{i}^{t} , … , {I}_{i}^{T - 1} , {O}_{i}^{T - 1} ) ,$$
wherein T is a time step length;
$${I}_{i}^{t} and {O}_{i}^{t}$$
represent inflow and outflow of area i at time step t; a similarity PCC_{i,j} between nodes vᵢ and vⱼ is defined as:
$${PCC}_{i , j} = \frac{{\sum }_{t = 0}^{T - 1} ( {F}_{i} ( t ) - \overline{{F}_{l}} ) ( {F}_{j} ( t ) - {\overline{F}}_{j} )}{\sqrt{{\sum }_{t = 0}^{T - 1} {( {F}_{i} ( t ) - \overline{{F}_{i}} )}^{2}} \sqrt{{\sum }_{t = 0}^{T - 1} {( {F}_{j} ( t ) - {\overline{F}}_{j} )}^{2}}} \qquad ( 5 )$$
wherein F̅ᵢ and F̅ⱼ are average flow values for area i and area j, respectively;
then, based on the set of area center points V and PCC similarities between nodes, an edge set Eₛ of the semantic graph is constructed using a complex network construction algorithm;
finally, based on distribution of POIs within each area, a semantic type is assigned to each area, resulting in the node type set Rₛ; for each area, all POIs within the area are first obtained, and then a semantic type is assigned to each area based on a POI category with highest distribution frequency in the area, defined as follows:
$${p}_{i}^{j} = \frac{{c}_{i}^{j}}{{\sum }_{k = 1}^{N} {c}_{k}^{j}} \qquad ( 6 )$$
$${R}_{i} = {arg max}_{j} {p}_{i}^{j} \qquad ( 7 )$$
wherein
$${c}_{i}^{j} and {p}_{i}^{j}$$
represent the number and distribution frequency of POI category j in area i, respectively; Rᵢ represents a semantic type of area i.

6. The method for predicting urban regional traffic flow considering multiple spatio-temporal granularities according to claim 5, wherein a specific process of constructing the edge set Eₛ of the semantic graph using the complex network construction algorithm comprises:
first, initializing Aₛ to be a zero matrix, indicating that initially, all nodes are disconnected, and each node forms a node group; then, performing an iterative merging operation on the node groups, wherein when the number of node groups is greater than 1, two most similar node groups are found based on similarities between node groups, the similarity between node groups being defined as a maximum PCC similarity from all node pairs between the node groups, most similar k pairs of nodes are selected from two node groups, and if a PCC similarity of two nodes in a pair is greater than a threshold λₛ, corresponding positions in Aₛ are set to 1, indicating that the two nodes are connected; merging the found two most similar node groups into one, and updating the similarities between the node groups; stopping the iterative merging operation when there is only one node group left; finally, setting diagonal values of Aₛ to 1, indicating that each node is connected to itself, resulting in final Aₛ through calculation, and obtaining edge connection relationships Eₛ, that is, the edge set.

7. The method for predicting urban regional traffic flow considering multiple spatio-temporal granularities according to claim 6, wherein step 5 is specifically implemented as follows:
constructing the STN blocks, wherein in the STN block, the distance graph and the semantic graph are processed separately using a graph convolutional network and a relational graph convolutional network, respectively, and are fused through a fully connected layer to obtain a spatial representation X_{S} at a specific temporal granularity:
$${𝒳}_{S} = {f}_{c} ( {f}_{g c n} ( {G}_{d} , {𝒳}_{r / d / w} ) + {f}_{rgcn} ( {G}_{s} ) ) \qquad ( 8 )$$
wherein X_{r/d/w} represents a specific flow sub-tensor: Xᵣ or X_{d} or X_{w}; and f_{gcn} f_{rgcn} represent the graph convolutional network and the relational graph convolutional network, respectively, while f_{c} is the fully connected layer; in f_{gcn}, residual connections are used to accelerate training convergence; and by fusing processing results of f_{gcn} and f_{rgcn}, a spatial representation of an urban area network is obtained;
then, capturing temporal dependencies by using a Non-stationary Transformer (NST) algorithm, resulting in a temporal representation at a specific temporal granularity, defined as:
$${𝒳}_{T} = {f}_{c} ( {f}_{NST} ( {𝒳}_{r / d / w} ) ) \qquad ( 9 )$$
wherein f_{NST} and f_{c} represent a non-stationary transformer layer and a fully connected layer, respectively; and
finally, concatenating the date attribute features Attr_{date}, the weather attribute features Attr_{wea}, the spatial representation X_{S}, and the temporal representation X_{T}, and passing combined data through the fully connected layer to obtain a spatio-temporal representation X̅.

8. The method for predicting urban regional traffic flow considering multiple spatio-temporal granularities according to claim 7, wherein a specific process of fusing the spatio-temporal representations of the data at each temporal granularity for flow predictions comprises:
first, processing the recent sub-tensor Xᵣ, the daily periodic sub-tensor X_{d}, and the weekly periodic sub-tensor X_{w} by using three STN blocks, respectively, to obtain spatio-temporal representations at each temporal granularity: X̅ᵣ, and X̅_{d}, and X̅_{w}, then fusing the obtained spatio-temporal representations:
$$\tilde{𝒳} = {f}_{c} ( {\overline{𝒳}}_{r} , {\overline{𝒳}}_{d} , {\overline{𝒳}}_{w} ) ) \qquad ( 10 )$$
then, inputting weather forecast information and a date attribute at a corresponding time point into the model as external factors to predict regional flow at time step T, with an output represented as:
$${\overline{Y}}^{T} = {f}_{c} ( \tilde{𝒳} , {Attr}_{wea}^{T} , {Attr}_{date}^{T} ) \qquad ( 11 )$$
wherein Y̅^{T} is predicted urban regional traffic flow at the time step T, comprising inflow and outflow, and
$${Attr}_{wea}^{T} and {Attr}_{date}^{T}$$
are weather attribute features and date attribute features at the time step T, respectively.
